(19) United States
(12) Patent Application Publication
(10) Pub. No.: US 2025/0092619 A1
(43) Pub. Date: Mar. 20, 2025

(54) COLD PLANER AUTOMATION

(71) Applicant: Roadtec, Inc., Chattanooga, TN (US)

(72) Inventors: Todd Avans, Soddy Daisy, TN (US); Ramon Pujol, Chattanooga, TN (US); Thomas Fagan, Chattanooga, TN (US)

(73) Assignee: Roadtec, Inc., Chattanooga, TN (US)

(21) Appl. No.: 18/962,611

(22) Filed: Nov. 27, 2024

Related U.S. Application Data
(63) Continuation-in-part of application No. 18/157,600, filed on Jan. 20, 2023.
(60) Provisional application No. 63/604,925, filed on Dec. 1, 2023.
(60) Provisional application No. 63/397,420, filed on Aug. 12, 2022.

(51) Int. Cl. E01C 23/088; E01C 23/12; G05D 3/20

(52) U.S. Cl. CPC E01C 23/088; E01C 23/127; G05D 3/20

(57) ABSTRACT

A system for positioning a working apparatus of a road construction machine, where first and second areas are located forward and rearward, respectively, of the working apparatus. A positioning system includes a controller for changing a position or orientation of the working apparatus. A computer system receives and processes topographical data collected by sensors for points of interest in the first area to generate a first plane equation for a first plane containing at least three of the points of interest. By comparing the first plane equation with an initial position, the computer system determines a second position where the working apparatus can change the road surface from a first state to a second state. The computer system generates instructions for changing a position or orientation of the working apparatus from the initial position to the second position, and the controller executes those instructions.

### CROSS-REFERENCE TO RELATED APPLICATIONS

This application is a continuation-in-part of Ser. No. 18/157,600, filed Jan. 20, 2023, the content of which is incorporated here by reference in its entirety. Further, this application claims the benefit of U.S. Provisional Application No. 63/604,925, filed Dec. 1, 2023, and titled “COLD PLANER AUTOMATION,” the content of which is incorporated herein by reference in its entirety.

### FIELD

This invention relates generally to positioning of a working apparatus on a road construction machine. More specifically, the invention relates to a system for positioning a working apparatus of a road construction machine with respect to the road construction machine and a road surface.

### BACKGROUND

During the construction of a road, a variety of road construction machines are utilized to carry out different processes in the road-building process. In carrying out many of those processes, the road construction machine must often and ideally travel relative to a fixed position of a road-building site. When resurfacing a road or constructing a new road surface, to prepare the road surface, specialized road construction machinery is often employed, including, but not limited to, milling machines, road stabilizers, road pavers, or street sweepers. In certain instances, the preparation simply requires cleaning the existing road surface. In other instances, the preparation requires removal of at least a portion of the existing road surface. Often, completing a road building task requires multiple passes of the road construction machine over the existing road surface, either over the same travel direction or over adjacent travel directions.

Now, in FIG. 1, a typical road-building site 100 is shown, which includes a partially-completed road surface comprised of a paved portion 102A with a freshly-painted line 104 and an unpaved portion 102B having an old painted line 106, which abut one another along a longitudinal joint or seam 108 between the paved portion 102A and unpaved portion 102B. When constructing a road surface, multiple road construction machines 110, sometimes collectively called a “paving train,” travel along the road-building site in a certain order and along a specific path, such as along the seam 108, to obtain a finished road surface that has the desired characteristics and features (e.g., smoothness, crowning, straight and accurate lines, etc.). The paving train of construction machines 110 might include, for example, a plurality of asphalt material supply trucks to provide a fresh supply of ready paving mix to the road-building site 100, a paving machine to receive paving mix from the supply trucks and to deposit the paving mix to form the new road surface over the unpaved portion 102B, and then a compactor for compacting and smoothing the newly-paved road surface. In some cases, a material transfer machine may be used to shuttle paving mix from the supply trucks to the paving machine so as to avoid possibly interrupting the paving process. During this process, certain machines of the paving train 110 might travel together along the paved portion 102A, such as the supply trucks and material transfer machine, while other machines of the paving train 110 travel along the unpaved portion 102B, such as the paving machine and compactor. Once the road surface is completed, a paint truck then generally travels along the new road surface and paints longitudinal center lines, lane lines, and edge lines to demarcate the various sections of the road.

In carrying out various steps of the road-building process, it is often important to do so carefully and accurately and along a specific path, such as along the seam 108. This would include, for example, the step of depositing the paving mix onto the unpaved portion 102B of the road-building site 100. In carrying out this process, paving mix should be deposited and formed in such a way that one paved section is placed adjacent and abuts the next paved section along the seam 108. Thus, in that case, the seam 108 can form a reference point or a fixed portion of the road surface that the paving machine must follow in order to obtain optimal results. If the paving machine fails to accurately travel along the seam 108, bumps or gaps may be created in the road surface, which would require rework and correction. Thus, having the ability to accurately guide a road-working machine along a desired pathway is important for an efficient and successful paving process.

Certain current methods for guiding a road construction machine along a desired path depend on the visual observation of an operator. One such method involves attaching a vertically-oriented or hanging chain to a portion of the road-building machine or from a portion of a strut extending from the machine. This chain is used as a visual guide for maintaining the road construction machine at a fixed distance away from a point of reference (e.g., seam 108). Generally, the chain is suspended vertically above the seam 108. As the road construction machine travels along the travel path, one person watches the chain to ensure that it remains vertically over the seam 108. That person then provides instructions to a machine operator to assist the operator in correcting the position of the road construction machine in order to maintain that desired position relative to the fixed portion of the road-building site 100 (e.g., maintaining the chain directly above the seam 108). Although this method can yield positive results, it is very labor intensive and requires the use of highly skilled operators and drivers. It also requires continual visual observation of the chain, which can make the use of this method labor and attention intensive (i.e., demanding operator attention over long periods of time). It can also be difficult at night or in otherwise darkened conditions (e.g., under an overpass or through a tunnel), which is when many road-building processes take place. Additionally, this method is very slow and dangerous, as it requires an operator to walk alongside the road construction machine.

An alternative method used to guide road construction machines along a desired path uses a camera system to identify and observe a fixed area of the road-building site 100. That observed area is then displayed to an operator via a display on the road construction machine (or elsewhere) and the operator must correct the position of the road construction machine or provide instructions for correcting the travel path of the road construction machine. While this method addresses the safety issue caused by placing personnel alongside the road construction machine, the process of continually monitoring the display while operating the machine can be very difficult and introduce new dangers. Additionally, as with the previously mentioned method, the accuracy of this method (i.e., the ability to guide the road construction machine along the ideal path) is limited by a number of human factors, including the visual capability of the human eye and the operator's hand-eye coordination.

Other systems used in connection specifically with paving machines utilize cameras to track reference points, such as the seam 108 between adjacent paved and unpaved portions 102A, 102B, in order to automate the positioning of a screed side plate of the paving machine, which impacts the width of the area that is paved by the paving machine. However, these systems still require the operator to operate (e.g., steer) the paving machine, which is a source for potential error and can limit the effectiveness of the camera tracking system. For example, even with automatic adjustment of the screed side plate, the road could be paved incorrectly if the paving machine, itself, is not correctly located. Additionally, this camera-based technology is limited to paving machines only and is not useful for other road construction machines, especially those machines that do not rely on seams 108 between paved and unpaved sections, 102A, 102B, to be correctly located at the road-building site 100, such as paint trucks.

In certain cases, for certain road construction machines, a seam 108 might not be available to guide the progress of the machine along the road-building site 100. This might be the case, for example, when forming the first paved section at a road-building site or when painting lines on a completed road. In those cases, alternative points of reference might be required. This might include, for example, the placement of a string line or the use of other repeating stationary reference points that are used to correctly position the road construction machine at the road-building site 100. However, placing these reference points can be time consuming and impractical. For example, a string line is useful for straight sections of road but not for curved road section. Attempts have also been made to use aspects of the road-building site itself, such as an edge of a road or a divider, to function as a suitable reference point. However, these site-based reference points are often inconsistent or too transitory to consistently function as a suitable reference point.

Next, when an existing road surface must be removed as part of the road building process, a machine 110, such as a milling machine or cold planer, shown in FIG. 2, may be used. Machine 110 includes a chassis 114 as well as propulsion devices, such as tracks 116, that are operatively mounted to the chassis and that allow the cold planer to travel and to be positioned at a desired location. Additionally, machine 110 includes a milling drum 118, and a conveyor 120. In operation, as the machine 110 moves along travel direction T via tracks 116, the drum 118, which contains a plurality of cutting tools (not shown) that are disposed radially around the drum, is placed in contact with the road surface while rotating in direction R. This interaction removes at least a portion of the road surface. By rotating in direction R, the drum 118 lifts and deposits the recently-removed road surface on conveyor 120, where it may then be conveyed to additional machinery or another selected deposit location. Height adjusters 122, shown as hydraulic cylinders, are typically disposed between the chassis 114 and the tracks 116 and allow the position (e.g., the height) of the chassis to be changed relative to the road surface. Drum height adjusters 124 are disposed between the chassis 114 and the drum 118 and allow the position and orientation of the drum to be changed relative to the road surface.

Now, with additional reference to FIG. 3, a partially milled road surface 126 is shown with an milled region 128 adjacent an un-milled region 130. In this view, an imaginary horizontal plane 132 has been positioned on a top surface of the un-milled region 130 at point 134. In preferred milling operations, precise adjustment of the position and orientation of the machine 110 produces the desired cut depth D, road slope S, and road grade G. Cut depth D refers to the amount of material removed in a vertical direction, such as between plane 132 and a bottom of the milled region 128 or between a portion of the un-milled region 130 or another reference point, such as a curb, shoulder, or other suitable reference. In this case, cut depth D is measured between the bottom (i.e., the lowest point) of milled region 128 and horizontal plane 132. Road slope S refers to the angle between a portion of the road surface 126 and horizontal (e.g., horizontal plane 132) when viewed normal to travel direction T. Road slope S may be constant across a road surface 24 or may vary depending on the desired road surface qualities like rain-shedding. Road grade G refers to the angle created between a portion of the road surface 126 and horizontal (e.g., horizontal plane 132) when viewed along travel direction T.

Before performing a milling operation, the machine 110 is preferably adjusted to produce the desired depth D, slope S, and grade G. This is accomplished, for example, by changing the distance or orientation of the chassis 114 relative to the tracks 116 using height adjusters 122, by changing the distance or orientation of the drum 118 relative to the chassis 114 via drum height adjusters 124, etc. However, due to the complex nature and relationship between depth D, slope S, and grade G, adjusting the machine 110 to produce the desired road surface can be difficult and time consuming. This is particularly true when the condition or state of the road surface varies. Further, features present in the road surface, such as manhole covers, sewers, reflectors, etc., often require the position or orientation of the machine 110 to be adjusted to produce the desired milled road surface. The milling process may be further complicated by the presence of debris piles, additional machinery, previous road surface damage, and/or site personnel that are located on or near the milling path.

Seeking to address these issues, some cold planers have incorporated cameras or vision sensors to observe the un-milled area in front of the cold planer and to provide feedback to an operator. For example, in those cases, a video feed or data stream produced by these cameras or sensors may be provided to the operator of the machine. The operator continually monitors the feed and then reacts appropriately, including by changing the position and orientation of the working apparatus relative to the road surface. Not only does monitoring these feeds and then correctly and repeatedly making the necessary adjustments require a highly skilled operator, but it also means the operator is less focused on other elements of machine operation. To assist the operator, certain current cold planers incorporate automation of certain functions of the machine. For instance, if a track dips with the road surface, the drum may be automatically adjusted or repositioned to compensate for the change in the track position.

However, these current systems are reactive in nature and can often produce unsatisfactory results. This is particularly true when inconsistent or unexpected objects, debris, etc. (generally referred to as “debris”) are present along the milling path. In such instances, with conventional systems, such debris may be detected as a change in the road surface by the milling machine. In response, the milling machine may be automatically adjusted to cause the milling drum to maintain the cut depth D based on the new, albeit incorrect, reference point of the debris pile. In that case, instead of an evenly milled surface with the appropriate depth D, grade G, and slope S, the resulting surface is potentially unacceptable and may require further work to correct. Alternatively, the debris or hazard might not be detected by the milling machine, which may result in damage to the machine itself, the road surface, or to nearby personnel. For example, if a manhole cover is located in the milling path but is not detected by sensors or identified by the operator, the position of the milling drum might not be changed in time to avoid the obstacle. In that case, the milling drum might contact and be damaged by the manhole cover. In addition to damaging the milling machine, this may also result in an improperly milled road surface in the vicinity of the manhole cover.

What is needed, therefore, are systems and methods for guiding a variety of road construction machines along a desired travel path at a road-building site and for automatically and accurately collecting and processing data related to a road surface and adjusting a position or orientation of a road construction machine based on that data, including when only sporadic or inconsistent reference points are available, and that decreases the skill required by the driver or operator of the road construction machine.

### NOTES ON CONSTRUCTION

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

The term “road construction machine” refers to a general class of machines utilized in the construction of roads. Examples of road construction machines are given in the description below.

### SUMMARY OF THE INVENTION

The above and other needs are met by a road construction system for positioning a working apparatus of a road construction machine with respect to the road construction machine and with respect to a road surface as the road construction machine travels along a portion of the road surface. The system includes the road construction machine and the working apparatus. The working apparatus is located on and is carried by the road construction machine such that a first area is located forward of the working apparatus and a second area is located rearward of the working apparatus. The system further includes a positioning system including a controller for executing instructions to change a position or orientation of the working apparatus with respect to the road construction machine and the road surface and a computer system having a processor for processing data. Additionally, the system includes one or more sensors that are configured to collect topographical data for three or more different points of interest in the first area and to provide the topographical data to the positioning system. The computer system is configured to process the topographical data to generate a first plane equation for a first plane containing at least three of the three or more different points of interest in the first area. The computer system is further configured to compare the first plane equation with an initial position of the working apparatus to determine a second position of the working apparatus calculated to enable the working apparatus to change the road surface from a first state to a second state in order to carry out a road construction operation. The computer system is also configured to generate instructions for changing a position or orientation of the working apparatus from the initial position to the second position. The controller is configured to receive the instructions from the computer system and to execute the instructions to cause the positioning system to move the working apparatus from the initial position to the second position.

### BRIEF DESCRIPTION OF DRAWINGS

FIG. 1 depicts a conventional road-building site having a paved portion abutting an unpaved portion along a longitudinal joint or seam;

FIG. 2 is a side elevation view of a conventional road construction machine;

FIG. 3 is a perspective view of a road surface having an un-milled region and a milled region;

FIG. 4 is a rearward-looking perspective view of a front portion road construction machine according to certain embodiments of the present invention;

FIG. 5 is a forward-looking perspective view of the front portion road construction machine shown in FIG. 4;

FIG. 6 is side elevation view of a portion of the road construction machine depicted in FIG. 4;

FIG. 7 is a cross-sectional view of a portion of a road surface having an un-milled region, a partially milled region, and a finally milled region;

FIG. 8 is a detail view showing a pair of distance-measuring sensors mounted to a ground contact point of the road construction machine depicted in FIG. 4;

FIG. 9 is a perspective view of a 3D model of a portion of a road surface shown in FIG. 4 that has been generated by a computer system according to certain embodiments of the present invention;

FIG. 10 depicts a portion of a working apparatus positioned above a cross-sectional view of a portion of a road surface having an un-milled region, a partially milled region, and a finally milled region;

FIG. 11 is a side elevation view that depicts a front end of a paving train that includes a milling machine and a dump trailer according to certain embodiments of the present invention;

FIG. 12 is a side elevation view that depicts a back end of the paving train of FIG. 10 and that shows the milling machine and an asphalt broom;

FIG. 13 is an isometric view of a road construction machine equipped with laser-based sensors of a machine guidance system (MGS) that may be used for guiding the road construction machine along a desired travel path at a road-building site, such as the road-building site shown in FIG. 1, according to certain embodiments of the present invention;

FIG. 14 is a representative 3-D model of a road-building site formed by a plurality of scans captured using laser-based sensors of a machine guidance system that replicates the road-building site shown in FIG. 1 and that may be used for guiding the road construction machine along a desired travel path at a road-building site;

FIGS. 15-17 depict three profiles that may be used by the MGS in simplifying and improving the creation of a 3-D model used for guiding road construction machines along a desired travel path at a road-building site;

FIGS. 18 and 19 depict conventional safety or shovel edges that are sometimes located along a roadway and that are preferably capable of being detected and analyzed automatically by the MSG; and

FIG. 20 is a top plan view of a road construction machine being guided along a desired travel path between two boundaries by a machine guidance system according to an alternative embodiment of the present invention.

### DETAILED DESCRIPTION OF THE INVENTION

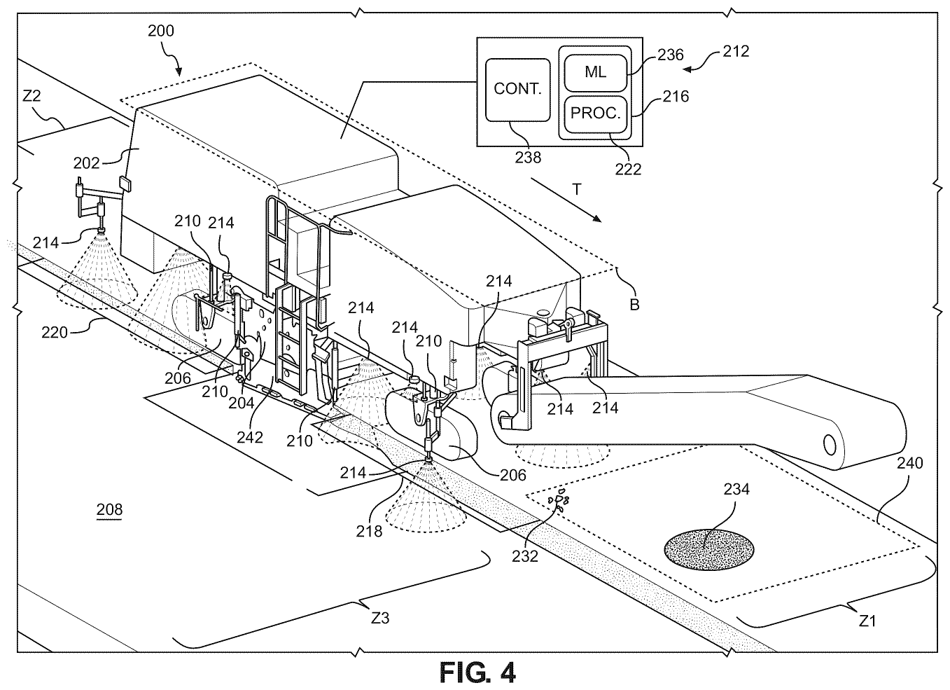

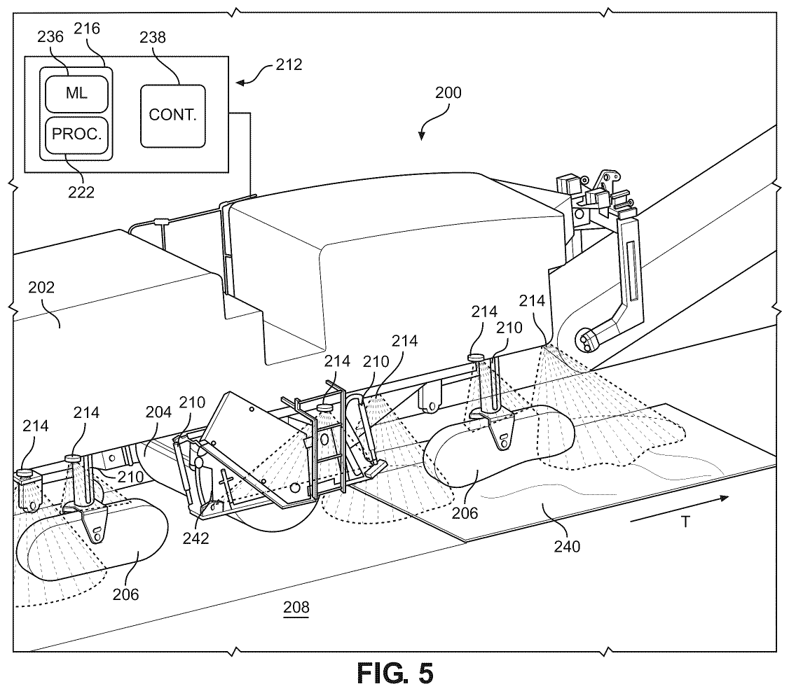

Referring now to the drawings in which like reference characters designate like or corresponding characters throughout the several views, there is shown in FIGS. 4-6 a road construction machine 200 that is carrying out a milling operation according to certain embodiments of the present invention. As discussed below, road surface 208 includes an un-milled road portion Z1 and the final desired road portion Z3.

The road construction machine 200 includes a chassis 202, a working apparatus 204, and a plurality of ground contact points (GCPs) 206 (e.g., driven wheels or tracks) that propel the road construction machine. Preferably, the road construction machine 200 is configured to travel along at least a portion of a road surface 208 in travel direction T while carrying out a road construction function (e.g., milling, paving, sweeping, etc.). Preferably, as the road construction machine 200 travels along the road surface 208, the working apparatus 204 contacts the road surface and performs a road construction function. For example, in certain embodiments, the road construction machine 200 comprises a cold planer or milling machine and the working apparatus 204 comprises a milling drum. In such cases, as the milling machine travels along the road surface 208, the milling drum contacts the road surface and removes at least a portion of the road surface. In this detailed description, the road construction machine 200 is shown and described as a milling machine, but the road construction machine may be a different type of road construction equipment that is known to those of skill in the art.

The working apparatus 204 and the GCPs 206 are both disposed on the chassis 202 and have an initial position but each is selectively movable to various positions and orientations. For example, the position and orientation, including the height, of the working apparatus 204 and GCPs 206 are each preferably adjustable with respect to the chassis 202 and road surface 208 using one or more motion devices 210. Although motion devices 210 are depicted as hydraulic cylinders, other linear motion and other devices, such as gears, power-screws, motors, etc., may be provided to enable the position and orientation of the working apparatus 204 and GCPs 206 to be adjusted. Accordingly, using motion devices 210 (or other similar motion device devices), the working apparatus 204 and the GCPs 206 each have an initial position and orientation, but are movable into various positions and orientations. As further explained below, by modifying the position and/or orientation of the working apparatus 204 or GCPs 206, work may be performed on the road surface to each a milled or worked road surface having desired characteristics, including depth, grade, and slope.

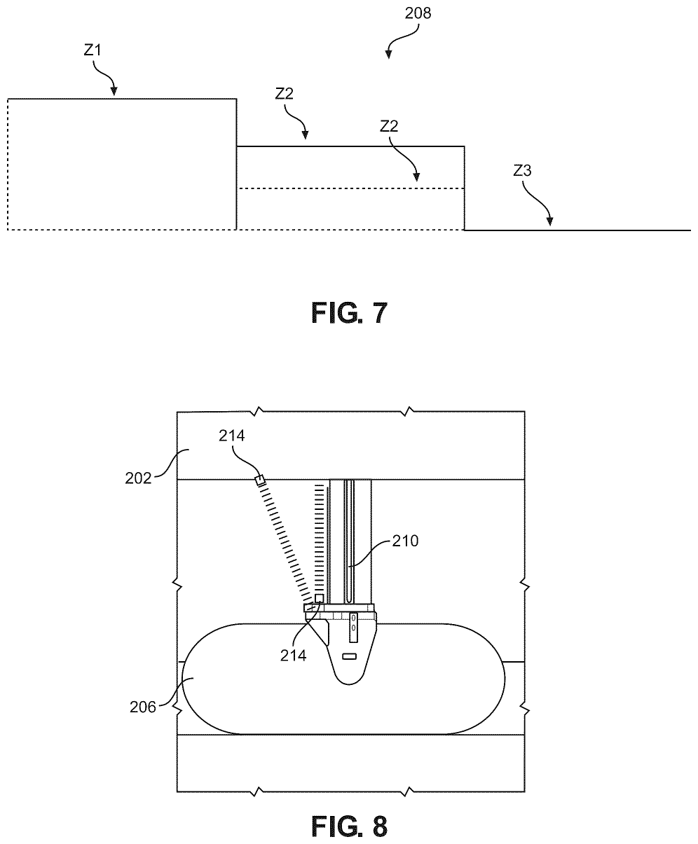

In certain embodiments, the road construction machine 200 may make several passes in which it travels over the road surface 208. For example, in one pass, the road construction machine 200 might mill a road surface 208 adjacent a previously-milled surface that has a final desired road profile (e.g., including depth, slope and grade). However, as depicted in FIG. 7, the differences between the un-milled road portion Z1 and the final desired road portion Z3, including the height, may be too great or too drastic to reliably achieve in a single pass. In such cases, therefore, one or more intermediate portions Z2 may be provided in the process of reconfiguring the road surface 208. The different intermediate portions Z2 may each be provided with a different depth, grade, or slope. Thus, in each pass, it may be necessary to reposition the working apparatus 204 with respect to the road surface to provide a road surface having the desired characteristics (e.g., depth, grade, or slope).

For this reason, referring again to FIGS. 4-6, the road construction machine 200 also includes a positioning system 212 for, among other things, positioning the working apparatus 204 with respect to the road surface 208. In certain embodiments, the positioning system 212 communicates with and is configured to work in conjunction with a plurality of sensors 214, preferably disposed on the chassis 202, and a computer system 216. In certain cases, certain sensors 214 are configured to sense the distance between the chassis 202 and the GCP 206. In preferred embodiments, as depicted in FIG. 8, sensors 214 used for this purpose are contactless distance measuring devices. These sensors 214 are preferably located external to rams and track assemblies associated with the GCPs 206 and are preferably not attached to the lifting column supports. Additionally, as shown in the illustrated embodiment, these distance-measuring sensors 214 may be mounted under the chassis 202 or on the GCP 206 itself. Additionally, these sensors 214 may be mounted at any convenient angle, including vertical or at an angle of inclination. Preferably, these sensors 214 are capable of remotely measuring the distance chassis 202 and the GCP 206. Referring again to FIGS. 4-6, in some cases, at least certain sensors 214 may divided into a first group that is configured to sense a first area 218 that is located forward of the working apparatus 204, and a second group that is configured to sense a second area 220 that is located rearward of the working apparatus. In certain embodiments, only the first group of sensors 214 is present. The sensors 214 can be a variety of sensor types but, as noted above, are preferably contactless sensors. The sensors 214 may include, but are not limited to, LIDAR, radar, point cloud, laser, ultrasonic, time-of-flight (TOF), stereoscopic, or video camera. The plurality of sensors 214 may be mounted inside and/or outside of a perimeter of the road construction machine 200 (the perimeter of machine 200 is represented by dashed line B in FIG. 4). In this embodiment, the perimeter B excludes the discharge conveyor disposed at the front of the machine 200. However, in other embodiments, the perimeter B may include such a conveyor.

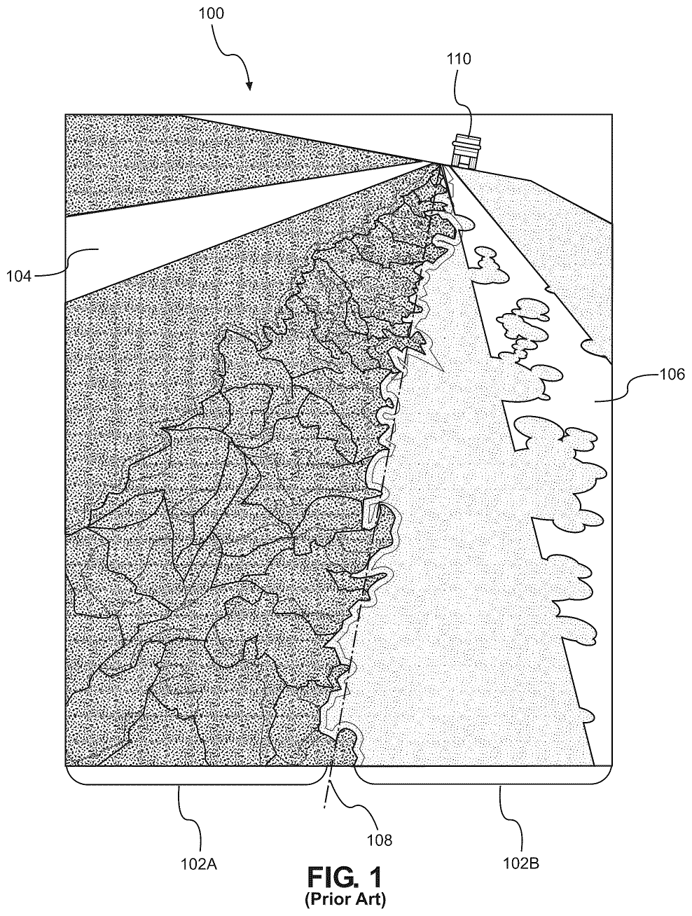

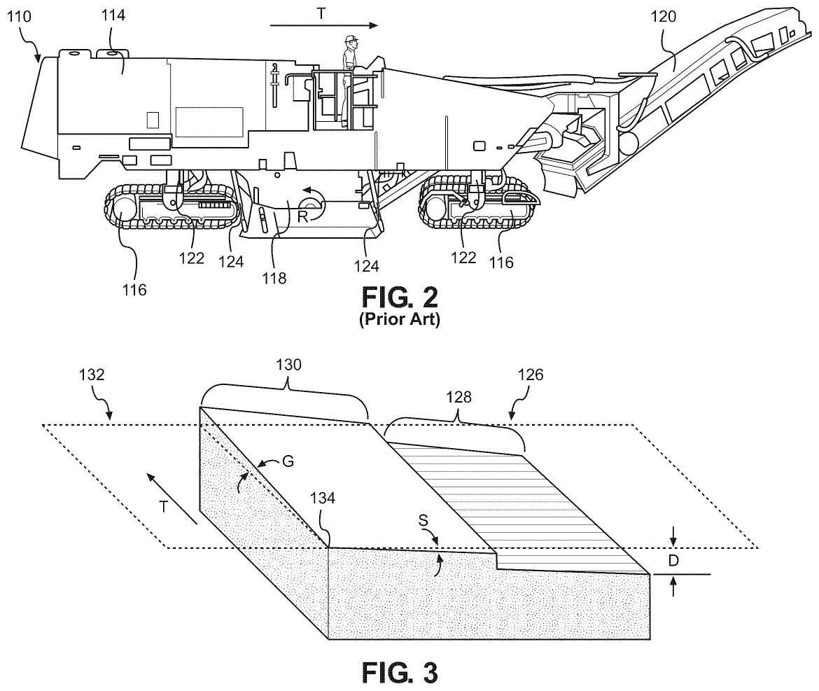

In preferred embodiments, the area 218 forward of the working apparatus 204 represents the area to be worked by the working apparatus and the area 220 rearward of the working apparatus represents the recently worked area. For example, in the case of a cold planer, area 218 may correspond to the un-milled portion Z1 (shown in FIG. 7) and area 220 may correspond to intermediate portion Z2 or to milled portion Z3. The sensors 214 may be positioned and arranged to observe area 218, area 220, or both, including simultaneously (e.g., observing the seam 108 shown in FIG. 1). As the sensors 214 scan the areas 218, 220, topographical data is generated related to those areas. However, as detailed below, the topographical data for area 218 and area 220 may be treated and processed differently. As used herein, “topographical” data may include information related to the road surface, surrounding structures or areas, debris or other objects located in or on the road surface or surrounding structures/areas, and the like.

Once created or acquired by sensors 214, the topographical data is preferably provided to the computer system 216. The computer system 216 is also preferably provided with initial position data of the working apparatus 204, which may include information related to the position and/or orientation of the working apparatus. This initial position data can be input by a user of the positioning system 212 or can be provided by a sensor 214 that is configured to detect the position and/or orientation of the working apparatus 204. The computer system 216 is also preferably provided with at least one operational constraint for the working apparatus 204. This operational constraint, which can be input by a user of the positioning system 212 or may be provided automatically by the computer system 216 or by another component of the positioning system 212 or of the road construction machine 200 generally, preferably controls the operation of the working apparatus 204. For example, the operational constraint may incorporate the desired depth, slope, and/or grade of the finished road surface 208, such as milled area Z3.

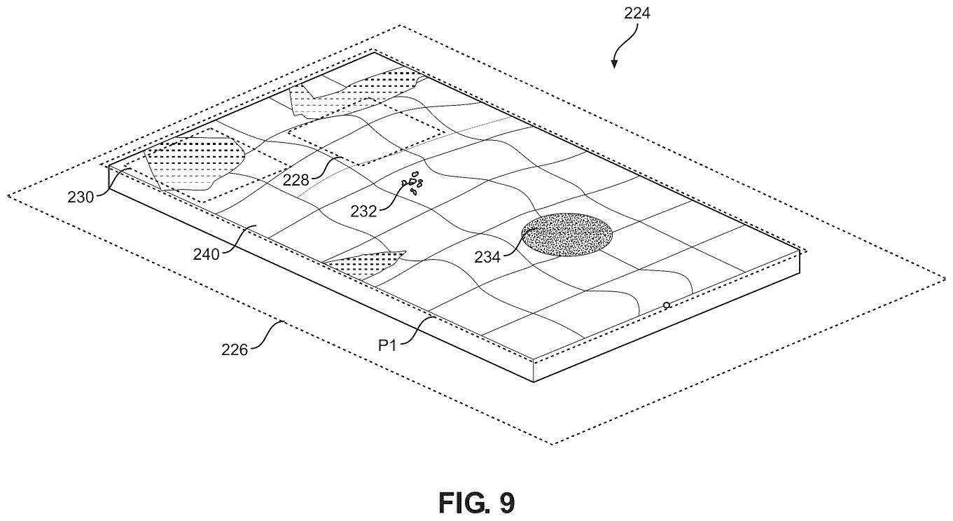

With continued reference to FIGS. 4-6 and with further reference to FIG. 9, the computer system 216 preferably includes a processor 222 that is configured to receive and process the initial position data and the topographical data acquired by sensors 214 to create one or more representative 3D models 224 of a selected area 226 to be worked. In certain instances, the road surface 208 includes inconsistencies, anomalies, or other features that may be captured by the sensors 214 and that may then be represented in the topographical data and in the model 224. In those cases, for example, the model 224 may include high regions 228 or low regions 230 that correspond to high or low regions of an inconsistency, anomaly, other feature, or even part of the road surface itself. These regions 228, 230 are positioned vertically above or vertically below, respectively, a representative plane P1 that preferably represents a “best fit” plane of the topographical data captured by the sensors for a selected area 226 of the area to be worked. The creation and use of this plane P1 and other representative planes in the road building process is described further below. The model 224 may also include other matter 232, such as debris, gravel, detritus, grass clippings, byproduct from previous milling operations, trash, etc. Additionally, objects 234, such as manholes, etc., that are embedded or otherwise present in the road surface 208 may be captured in the model 224.

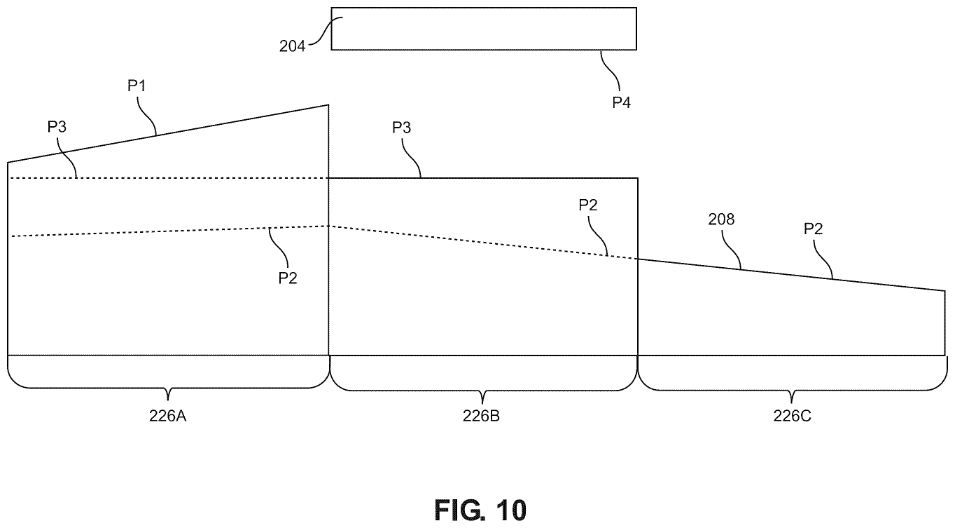

Now, with reference to FIG. 10, three selected areas are shown, including a first selected area 226A that has not been worked at all and provides an un-milled surface, a second selected area 226B that has been worked once (i.e., via a first pass) and is about to be worked a second time (i.e., via a second pass) by the working apparatus 204 and that provides intermediate surface, and a third selected area 226C that has already been worked using the working apparatus and that has a finished road surface 208 and finished milled area.

With continued reference to FIG. 10 and referring also to FIGS. 4-6 and 9, the processor 222 may be further configured to generate a plane equation for the first plane P1 described above, which preferably represents the best-fit plane of the topographical data captured by the sensors for each selected area 226 of the area to be worked. The surface of this plane P1 and the other planes described herein that are generated by processor 222 are created using a minimum of 3 “points” or 3 separate mapped positions of the selected area 226. However, more than 3 points may be used by processor 222 in generating each plane.

This first plane P1 preferably represents the present state of the selected area 226 before it is worked via the working apparatus 204. The processor 222 may be further configured to determine a second plane P2, which represents the desired state of the selected area 226 after it is worked via the working apparatus 204 to achieve the desired characteristics. Thus, when prepared for use in connection with a cold planer or milling machine, where material is removed from the road surface, second plane P2 is located at least partially or entirely vertically below first plane P1. On the other hand, if used in connection with a paving machine, where material is added to the road surface, second plane P2 is located at least partially or entirely vertically above first plane P1. Next, the processor 222 may be further configured to determine one or more third planes P3, which represent intermediate surfaces that are between first plate P1 and second plane P2. Finally, the processor 222 may be further configured to generate a plane equation for a fourth plane P4 that represents the initial position and orientation or the current position and orientation of the working apparatus 204.

In generating the model 224, absent data processing or filtering, every inconsistency or anomaly in the road surface would potentially be included in the model. Including these inconsistencies, anomalies, etc. would potentially result in the introduction of errors, inaccuracy, and the like into the model 224, including the plane equations of the various representative planes (e.g., P1 thru P4). For instance, if low region 230 were created by a damaged road surface 208, processing unfiltered topographical data would potentially produce an artificially low plane equation. Thus, in certain embodiments, the processor 222 preferably employs one or more of statistical analyses, advanced filtering, such as a Kalman filter, and other similar steps while processing data from the sensors 214 to ensure that an accurate plane equation is obtained. This filtering process may, for example, remove or disregard certain data obtained by the sensors 214, such as regions that are likely inconsistencies or anomalies. In preferred embodiment, if the detected inconsistency on the surface has certain characteristics (e.g., smaller than a certain size, detected by only sensor, or larger than a certain size), it is automatically disregarded and is not used for the creation of planes or in the automated control of the working apparatus 204.

Alternatively, or additionally, where the inconsistency does not possess those characteristics (e.g., is too large or is detected by more than one sensor), the computer system 216 may still be configured to determine if the data belongs to the actual road surface or is an anomaly or inconsistency that should be ignored. For example, in certain cases, the computer system 216 may be provided with a machine learning (ML) engine 236 to work in conjunction with processor 222. Preferably, the ML engine 236 is trained to identify and distinguish features or characteristics that are relevant to the plane equation calculation from those that are not. For example, if the road surface 208 includes items like matter 232 and/or objects 234, the ML engine 236 is or may be trained to recognize and distinguish between items that should be included in the plane equation calculation, items that should be disregarded in the calculation, and items that should generate an alarm. For instance, in some cases, high region 228 and/or low region 230 may be included in the determination of the plane equation. Whether to include these features might depend, for example, on how consistent they are with the entire data set representing the area being observed. In other instances, the ML engine 236 may filter out or ignore the data related to the matter 232 based on comparisons with other datasets, including debris.

In other cases, the ML engine 236 might compare the data related to the objects 234 with other datasets, including manholes, and the processor 222 might then generate an alarm to warn personnel of the presence of the hazard such that appropriate or corrective action might be taken or such corrective action might be taken automatically. For example, the processor 222 might compare the position of working apparatus 204 and/or GCPs 206 against the inconsistency. Based on this comparison, the processor 222 is preferably configured to determine, among other things, whether working apparatus 204 and/or GCPs 206 will undesirably contact (and potentially be damaged by) the inconsistency. If so, the processor 222 might be configured to generate instructions to automatically move the working apparatus 204 and/or GCPs 206 or to stop the road construction machine 200 entirely.

In certain of these cases, to make the determinations described above (e.g., include feature, exclude feature, or generate an alarm), the processor 222 creates or is provided with a tolerance band related to the topographical data. In these embodiments, if the topographical data falls outside of the tolerance band, at least a portion of the topographical data may be disregarded by the processor and/or an alarm may be generated.

The computer system 216 then compares the plane equation P4 of the working apparatus 204 to one of the other plane equations to determine if the working apparatus is appropriately positioned to change the road surface 208 from a first state to a desired second state. For example, the first state might be an un-milled road surface, which may be represented by plane P1, and the second state is a partially milled road surface having an intermediate road surface represented by plane P3 or is a milled road surface having a final road surface represented by plane P2. In other embodiments, such as embodiments where the road construction machine is an asphalt broom and the working apparatus is a broom, the first state may be un-swept, and the second state may be swept.

In each case, if the working apparatus 204 is not positioned correctly based on the processor's comparison of the plane equations and/or the respective positions and orientations of the working apparatus 204 and the surface(s) that are to be worked, the computer system 216 preferably generates commands for moving the working apparatus 204 to a second position that is calculated to enable the working apparatus to change the road surface from the first state to the desired second state. In certain embodiments, the instructions are then provided to the user of the positioning system 212, who can manipulate the position of the working apparatus 204 using the instructions. In certain other embodiments, the positioning system 212 further includes a controller 238 for manipulating certain aspects of the road construction machine 200. For example, the controller 238 may be configured to receive the instructions from the computer system 216 and to then execute those commands to change the position of the working apparatus 204.

In certain embodiments, positioning system 212 uses the second group of sensors 214 to generate data related to the recently worked area 220 that is located rearward of the working apparatus 204. In such cases, the data collected by the second group of sensors 214 may serve two important functions. First, the data may be provided to the computer system 216 for comparison with the plane equation data. For example, by comparing a first data set that represents the un-milled area 218 and with a second data set that represents the recently worked area 220, the computer system 216 can confirm whether the working apparatus 204 is correctly positioned and oriented. If the data representing the recently worked area 220 does not indicate correct positioning of the working apparatus 204, the computer system 216 preferably generates commands to change the position and/or orientation of the working apparatus to improve its position or orientation. This process may be repeated, including continuously, while the road construction machine 200 moves along the road surface 208. In certain cases, the positioning system 212 and the sensors 214 are configured to detect the edge or seam (e.g., seam 108, shown in FIG. 1) between a milled region and an adjacent unmilled region as well as the heights of those two regions. By comparing the locations of these two areas, the depth of the cut can be obtained. This information can be used as feedback for the entire system to improve the control loop. Similar information can be obtained by a simple subtraction of the uncut (i.e., un-milled) surface and the freshly-cut (i.e., milled) surface. Either or both methods may be used. By using both methods, the calculations can be double checked and accuracy corroborated.

Second, the topographical data collected by sensors 214, including data related to the recently worked area 220, can be retained by the computer system 216 for future use. For example, if the road construction machine 200 undertakes multiple passes of road surface 208 to perform the desired function, the topographical data may be used to calculate the ideal position of the working apparatus 204 for subsequent passes. Using historical data allows the computer system 216 to generate a more accurate model and plane equation. In certain instances, the data is provided to other road construction machines utilizing positioning systems like the positioning system described above. For example, after a cold planer performs the milling function, a road paving machine may lay asphalt on the recently milled surface. In that case, when provided with data related to the freshly milled surface, the road paving machine is likely able to lay asphalt more accurately and efficiently than it would be able to in the absence of such data, thereby resulting in a higher quality end-product that is preferably produced at a lower overall cost and in less time.

As noted previously, GCPs 206 are height adjustable via motion devices 210. As the road construction machine 200 travels along the road surface 208, data collected and generated by the GCP-sensing sensors 214 may be provided to the computer system 216 and then used by the processor 222 to generate plane equations. Advantageously, unlike conventional road construction machines, where a change in the position of the GCPs 206 would immediately result in a change in the position of the working apparatus 204, receiving the data associated with the GCP sensor 214 in this case is preferably only a part of the calculation for the plane equation and the resultant positioning of the working apparatus 204. Preferably, the computer system 216 and the processor 222 rely on data from several (i.e., more than one) sources of data to determine each of the plane equations.

For example, with reference to FIGS. 4-6 and 9, if the GCP 206 travels over debris field 240 located within selected area 226, the processor 222 compares the data generated from the GCP sensor 214 with the other data gathered by the first group of sensors. The processor 222 determines if the debris field 240 requires an adjustment of the working apparatus 204, based on the plane equation, or if the debris field can be disregarded. Utilizing multiple sensors 214 within the first group of sensors 214, the positioning system 212 has a more complete and accurate data set related to the road surface 208 than if only monitoring a single sensor. Further, because certain sensors 214 within the first group of sensors can sense the debris field 240 prior to the GCP 206 reaching it, the processor 222 can generate instructions to move the GCP out of the way of the debris via the motion device 210. This eliminates unnecessary movement of the working apparatus 204 and reduces operator strain.

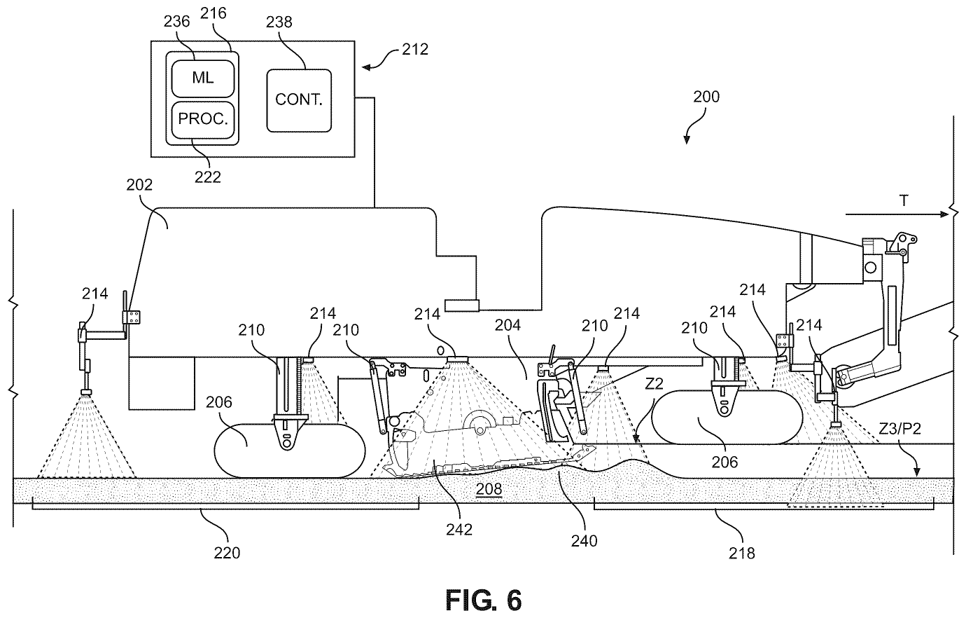

In certain further embodiments, certain sensors 214 are configured to sense the position of the endgate 242, which attaches to the working apparatus 204. For example, in FIG. 6, endgate 242 is following the previously-milled surface (e.g., Z2) when it encounters debris field 240. In the past, without positioning system 212 and processor 222, the presence of the debris field 240 may have resulted in working apparatus 204 being undesirably raised to avoid the anomaly. However, since virtual plane P2 is created by a suite of sensors 214, the debris field 240 can be virtually removed and the working apparatus 204 will maintain its correct position and orientation.

In these embodiments, the data associated with the endgate sensors 214 is provided to the computer system 216 for processing, along with the other data gathered by other sensors located in front of and/or behind working apparatus 204 as well as the GCP-sensing sensors (if present). Conventionally, in the absence of this kind of suite of sensors, movement of the endgate 242 might have resulted in an immediate change in the position of the working apparatus. While this movement might be desirable in some cases, it might not be desirable in other cases. However, in road construction machine 200, sensors 214 preferably sense a large area with multiple sensors, and the computer system 216 may be configured to see the data that is collected only by endgate sensors 214 as anomalous when compared to the other data that is collected. In that case, the data collected by the endgate sensors 214 may be disregarded and not used in computing the plane equation.

In preferred embodiments, the system described above acts automatically and no action or decision by an operator is required when the position and/or orientation of the working apparatus 204 is changed. Further, no action or decision of the operator is required when selecting the appropriate reference point, detected area, sensor, etc. that is used in determining the position or orientation of the working apparatus 204; instead, these decisions are made automatically by the positioning system 212. Additionally, the process described above utilizes a suite of sensors, including a variety of sensors that are located at various locations on or around the road construction machine 200. For example, sensors might be used in or, more preferably, on the endgates (e.g., inclinometers, smart cylinders, linear encoders, etc.), vision sensors might be placed around and in the machine's footprint, external measuring devices might be located between the chassis and the GCPs. During operation of the road construction machine, some or, more preferably, all these sensors operate all at the same time. Thus, with these systems and methods, profiles of existing road surfaces and of desired or intermediate surfaces can be automatically predicted or generated. Additionally, a profile, which can be used to determine the position and orientation of the working apparatus 204, is also preferably automatically predicted or generated. Advantageously, the operator is not required to make these determinations. The positioning system 212 preferably analyzes each sensor and the data it collects and then compares that data to the surface equations that were created using the suite of sensors. If one sensor's data does not match these equations, that data or that sensor can be temporarily disregarded or removed from consideration, thereby avoiding undesirable deviation from the desired profile or movement of the working apparatus 204.

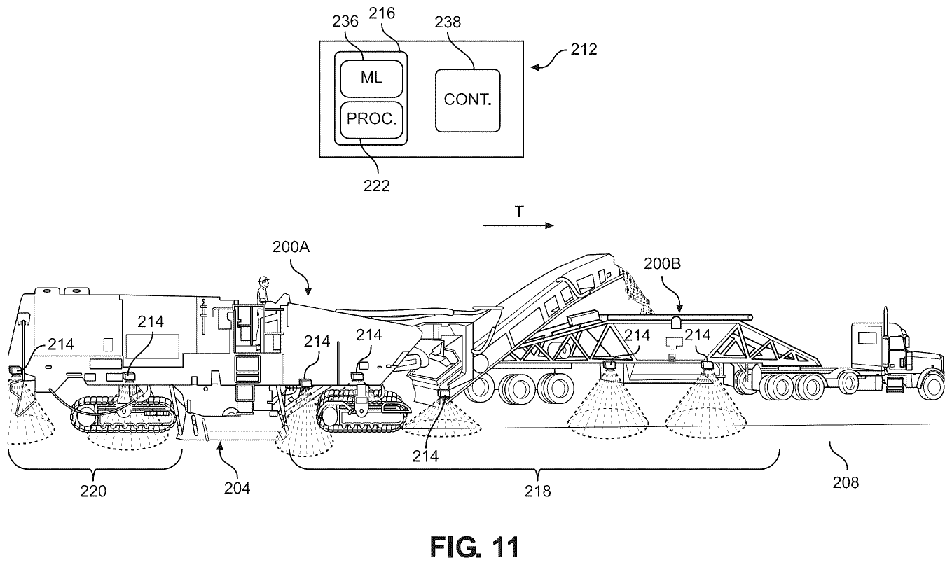

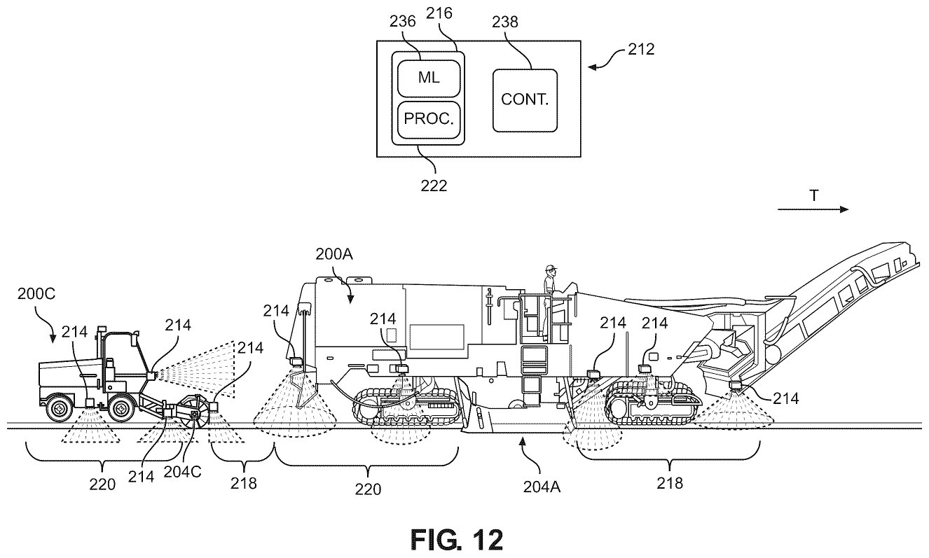

With reference now to FIGS. 11 and 12, in certain embodiments, a first road construction machine 200A having a first road construction apparatus 204A forms part of an asphalt paving train. As in prior embodiments, road construction machine 200A is a milling machine or cold planer that is used to mill up the road surface. This road construction machine 200A works in conjunction with additional road construction machines, such as dump trailer 200B and/or asphalt broom 200C, which carry out various tasks in the paving process. Dump trailer 200B is located forward of and is offset from the road construction machine 200A, and asphalt broom 200C is located behind and follows road construction machine 200A. The other road construction machines forming the asphalt paving train may provide additional road construction apparatuses. For example, asphalt broom 200C provides a second working apparatus 204B in the form of a broom.

In operation, dump trailer 200B receives milled asphalt that is discharged from the discharge end of discharge conveyor of road construction machine 200A. Additionally, at the same time, asphalt broom 200C might follow the road construction machine 200A and sweep the road surface to prepare it for subsequent operations, e.g., additional passes of milling machine or paving machine. One or more positioning systems 212 preferably provide instructions for repositioning of working apparatuses of the road construction machines 200A, 200B, 200C, including the first road construction apparatus 204A of a first road construction machine 200A and the second road construction apparatus 204B of asphalt broom 200C, based on data from sensors 214. However, in this case, the plurality of sensors 214 may be mounted on the road construction machine 200A as well as on the dump trailer 200B, asphalt broom 200C, other machines forming the paving train, or to surfaces proximate the paving training or paving location. For example, sensors 214 located on the first road construction machine 200A and/or on dump trailer 200B may collect data that may then be used to generate topographical data related to the area 218 forward of the first working apparatus 204A. At the same time, sensors 214 located behind the first working apparatus 204A may collect data that may then be used to generate topographical data related to the area 220 rearward of the first working apparatus. This information may then be provided to machinery (e.g., asphalt broom 200C) following the first road construction machine 200C or it may be provided to machines in front of the first road construction machine or to the first road construction machine itself in order to adjust the position and orientation of the working apparatuses carried by those machines in the manner described previously.

In certain other embodiments, other machinery, such as the asphalt broom 200C are provided with a positioning system 212 for positioning a second working apparatus 204B. The same or similar positioning systems may be used for each machine and working apparatus. In this case, for the asphalt broom 200C, areas 218, 220 might represent a swept area and an un-swept area, respectively. Thus, using information obtained from the first and second groups of sensors 214, a broom 200C may be correctly positioned with respect to the road surface. However, in certain embodiments, in addition to or in place of information from the sensors 214 associated with the asphalt broom 200C, the computer system 216 associated with the asphalt broom or with the second working apparatus 204B may be configured to use data associated with the first working apparatus 204A or with another working apparatus that is located either behind or, more preferably, in front of the second working apparatus. In those cases, that other topographical data may be provided to the computer system as an alternative to creating new topographical data using at least the sensors 214 associated with the second working apparatus 204B. This is possible because the area located behind the first working apparatus 204A and in front of the second working apparatus 204B can sometimes represent or at least approximate the same area in a paving train. Thus, data captured by one set of sensors 214 (e.g., those located on the first road construction machine 200A) may be substituted in place of data that would otherwise have been captured by the sensors associated with the asphalt broom 200C. Alternatively, data collected by sensors associated with more than one road construction machine may be combined together, thus increasing the amount of topographical data utilized for subsequent processes.

Preferably, after the topographical data has been acquired, it is used in a similar manner as described above, including to create a 3D model of portion of the road surface and to generate a plane equation. The computer system then compares the plane equation to the initial position of the working apparatus and the operational constraint and determines if the working apparatus is appropriately positioned to change the road surface from one state to another state. For example, if the road surface was previously changed from a first state (e.g. un-milled) to a second state (e.g., milled but unswept) by a first road construction machine, it may later be further modified to a third state (e.g., milled and swept) by a second road construction machine. In each case, if any of working apparatuses are not positioned correctly, the computer system preferably generates instructions for moving the working apparatus to a position calculated to enable the working apparatus to change the road surface in the manner desired.

In certain embodiments, the positioning systems and/or computer systems detailed above may be separate systems provided on each of the working apparatuses. However, in other embodiments, varying numbers of positioning systems and computers systems may be used for the various machines in the paving train. For example, in certain embodiments, a single positioning system and a single computer system is used to control the entire paving train. In such cases, data from sensors located on or near each machine may be communicated to positioning and computer systems via one or more wired or wireless networks or communications channels. Additionally, commands may be communicated to on-board controllers located on or near each machine via one or more wired or wireless networks or communications channels.

Finally, referring again to FIGS. 4-6, also provided herein is a method for positioning the working apparatus 204 described above with respect to a road construction machine 200 and a road surface 208 using the positioning system 212 and sensors 214. In this method, an initial position and a desired operational constraint of the working apparatus 204 is provided to the positioning system 212. The first group of sensors 214 generates data depicting the area 218 forward of the working apparatus 204, and that data is provided to the computer system 216. Using the data, the processor 222 then generates a representative model of the road surface 208 and generates a plane equation corresponding to the road surface. In certain embodiments, the method includes providing the processor 222 with a tolerance band related to the plane equation. In other embodiments, the processor 222 generates the tolerance band based on one or more of the data that is collected or provided and data processing filters (e.g., Kalman filter). The method may further include generating an alarm if data collected by the sensors falls outside of the tolerance band.

In embodiments incorporating the ML engine 236 into the computer system 216, the method may include analyzing the sensor data using the ML engine to determine if the sensor data corresponds with the road surface or to an anomaly, such as matter 232 or objects 234. In certain cases, the computer system 216 disregards or exclude at least a portion of the data in generating the plane equation. For example, the computer system 216 may disregard or filter out data associated with debris while calculating the plane equation. In other instances, an alarm is generated and issued in response to the data collected by the sensors. For example, if the data indicates that a manhole or that debris is in the road surface 208, a related alert may be generated by the computer system 216 and then that alert may be provided to personnel or cause the working machine 200 to take action, including automatically taking action (e.g., stop moving).

The computer system 216 preferably then compares the plane equation, the operational constraint, and the initial position of the working apparatus 204 and determines if the working apparatus 204 needs to be repositioned to perform the desired function in conformance with the operational constraint. If so, the computer system 216 generates commands that will cause the working apparatus 204 to move from a first position or orientation to a second position or orientation, where the second position or orientation is calculated to enable the working apparatus to perform the desired function in conformance with the operational constraint. Those commands are provided to and then carried out by the controller 238 to manipulate the position or orientation of the working apparatus 204 (and/or to modify other conditions of the road construction machine 200). While the road construction machine 200 is moved along travel direction T and as the working apparatus 204 operates on the road surface 208, the area 218 may be scanned again, including continuously, by sensors 214 to collect new data that is provided to the computer system 216. This new data is then used to repeat the analysis described above and, when required, new commands are generated and issued.

In certain embodiments, the area 220 rearward of the working apparatus 204 is scanned by scanners 118 and the collected data is provided to the computer system 216. This data is then compared with the plane equation and the operational constraints to determine if the resulting worked area accurately reflects the predicted condition, or if the working apparatus 204 needs to be re-positioned. If repositioning is required, additional commands for placing the working apparatus in a third position are generated by the computer system 216 and implemented by controller 238.

In other embodiments, the positioning system 212 further includes a GCP sensor 214 configured to sense the distance between the GCP 206 and the chassis 202 and generate height data related to the distance. Height data collected by these sensors 214 is provided to the computer system 216 and is used to generate the plane equation. If the height data indicates that the height of the GCP 206 should be adjusted to maintain the position of the working apparatus 204, the computer system 216 generates commands for making the appropriate height adjustment. Those commands are provided to the controller, which manipulates the position or orientation of the GCP in accordance with the commands.

In certain cases, at least a portion of the data collected by the sensors 214 and the plane equation(s) are saved and then used during a later operation, including by the road construction machine 200 or by a different road construction machine. For example, when the road construction machine 200 makes a second pass, data generated during the first pass may be used, including by being combined with new or different data, which may be collected by the same sensors 214 that collected the original data or by different sensors, to calculate a revised plane equation and to generate commands to move the working apparatus 204 to a new position or orientation. For example, if the total desired depth D of the milling operation is 5″ and the first pass removed 3″ of the road surface, commands generated by the computer system 216 may instruct the working apparatus 204 to remove the remaining 2″ while accurately following the plane equation created during the first pass.

As shown in FIGS. 11 and 12, in certain embodiments, the method includes a step of providing a second road construction vehicle, such as dump trailer 200B or asphalt broom 200C. Preferably, in such cases, the second road construction vehicle leads or follows the road construction machine 200 along the travel direction T. For example, asphalt broom 200C follows road construction machine 200A in a position adjacent and behind the road construction machine. The positioning system 212 includes a computer system 216 having a processor 222 and, in certain embodiments, an ML Engine 236. The positioning system 212 may also include or work in conjunction with a plurality of sensors 214 that are disposed on or near the asphalt broom 200C. The positioning system 212 may also include a controller 238 that receives and executes instructions generated by the computer system 216 to change the position and/or orientation of the working apparatus 204.

As a next step, the initial position of the working apparatus 204 is provided to the computer system 216, along with any desired operational constraints. For example, if the apparatus is a broom, the desired operational constraint might be a desired contact force between the road surface 208 and the working apparatus 204. The desired operational constraint may differ in other cases, such as with a different second road construction machine. Next, the road construction machines 200A, 200B, 200C move along the travel direction T, changing the road surface from one state to another state, as described above. As the road construction machines move, sensors observe the nearby areas 218, 220 of the road surface 208 and generate topographical data or verify that the working apparatus 204 is operating in an appropriate fashion (e.g., creating the desired road surface conditions). In certain embodiments, the two of the same type of road construction machines are provided in a road construction train. These road construction machines can, of course, perform the same function as each other or may carry out different functions.

### Vision Guidance

The systems and methods described above for positioning a working apparatus of a road construction machine with respect to the road construction machine and a road surface as the road construction machine travels along a portion of the road surface may be used cooperatively with the systems and methods disclosed in co-pending application Ser. No. 18/157,600, entitled “System and method for automatically guiding a road construction machine,” the entire contents of which are incorporated into this application by reference.

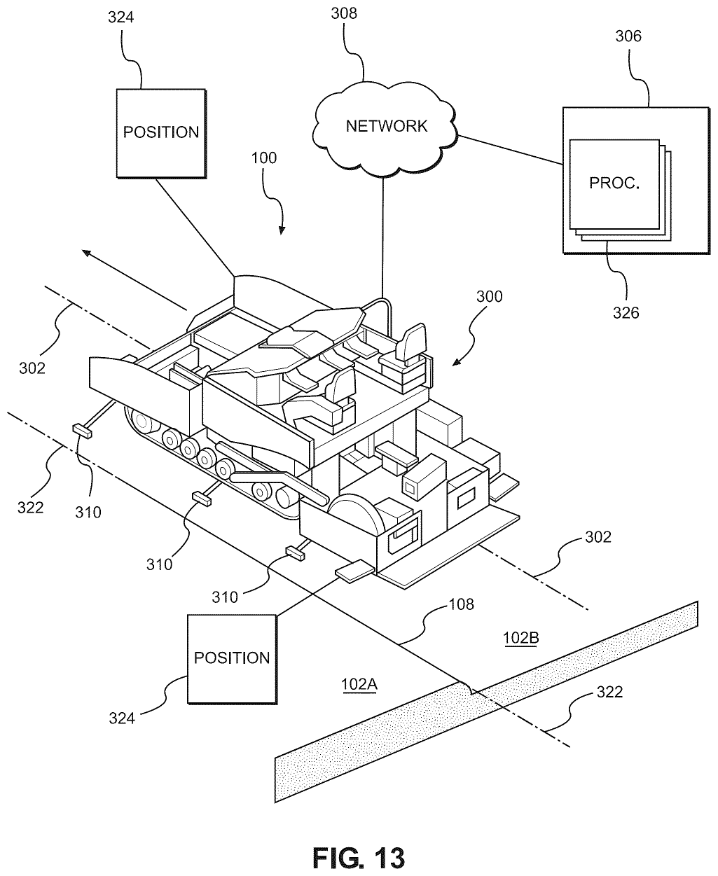

With reference now to FIG. 13, a road construction machine 300 that may be guided along a desired travel path 302 at a road-building site 100 (FIG. 1) according to embodiments of the present invention is shown. The machine 300 is preferably guided (e.g., steered) automatically by a machine guidance system (or “MGS”) 306 along the desired travel path 302, which essentially functions as a “flight plan” for the machine. Machine 300 may be in direct communication with the MGS 306, which may be located partially or exclusively on the machine, or may communicate with the MGS (or a portion thereof) over a wireless network 308. While the road construction machine 300 is depicted in FIG. 13 as a paving machine, it should be understood that the system and method disclosed herein may be used to guide a variety of road construction machines that each carry out unique tasks at the road-building site 100. As non-limiting examples, the machine 300 could be a paver, a road mill, a cold planer, an asphalt broom, a haul truck, a dump truck, a material transfer machine, a soil stabilizer, a soil reclaimer, a compactor, a paint truck, or other similar machines.

As shown, the machine 300 is equipped with a plurality of sensors 310 (e.g., lasers or other similar light scanning devices). Sensors 310 may be identical to or different from sensors 214 described previously. In this particular illustration, sensors 310 are shown on only one lateral side of machine 300. However, in other cases, sensors 310 may be located in any convenient location on or around the machine 300. As the machine 300 travels in travel direction T along a longitudinal extent of site 100, sensors 310 capture and record multiple images or scans of the road-building site 100, which are preferably 3-D scans of the road-building site 100. These scans may be captured using continuous or variable surface scan rates. The scans are then combined to form one or more combined 3-D scans of the longitudinal boundary condition(s) at the road-building site 100, which then functions as a representative model of the road-building site.

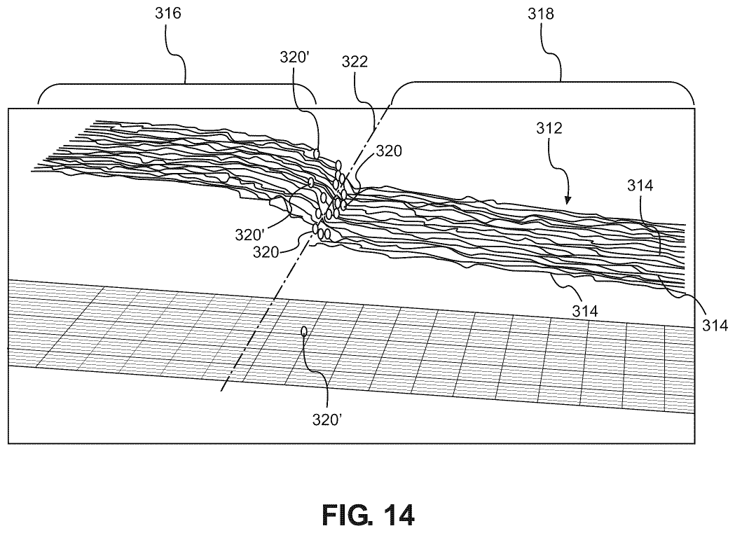

Now, shown in FIG. 14 is a representative model 312 of a portion of the longitudinal boundary condition of a road-building site 100 shown in FIG. 1. This model 312 is formed from a plurality of individual scans, which are represented here within the model 312 by three-dimensional scan lines 314, and which are captured by sensors 310 of the presently disclosed system as noted above. As shown, the model 312 includes a first portion 316 that corresponds to the paved portion 102A of the road-building site 100 and a second portion 318 that corresponds to the unpaved portion 102B of the road-building site 100. The position of the seam 108 between the paved portion 102A and the unpaved portion 102B may be used as a reference line for guiding a road construction machine 300. The portion of the model 312 that corresponds with a real-life reference point, such as the seam 108, are referred to herein as critical points 320.

The critical points 320 preferably identify certain features or elements that repeat, either continuously or discontinuously, along the desired travel path 302. In this particular case, the critical points 320 correspond to locations along the center of the seam 108 between the paved portion 102A and unpaved portion 102B of the road-building site 100. However, in other cases, other portions of the same reference point may be used as critical points 320 (e.g., top or bottom edges of the seam). Similarly, in place of a seam 108, other types of real-life reference points could be used and then represented within the model 312 as critical points 320. For example, any of the following types of features could function as a suitable reference point: a normal straight cut edge of a paved area, a painted line at the road-building site 100, a median, a curb, a landscape edge, or any other element that preferably runs along the longitudinal extent of the road-building site.

By plotting a line 322 within the model 312 through these various critical points 320, a desired travel path 302 for road construction machines can be digitally modeled. Line 322 can represent and be disposed along the desired travel path 302 of the machine 300. Alternatively, and more preferably, the line 322 can be used, in combination with other data, to determine the actual desired travel path 302 of the machine 300. It is unlikely that all machines 300 would need to travel precisely along the same line 322 and, for that reason, it is more advantageous to derive a desired travel path 302 based on the line 322 rather than using the line, itself, as the travel path. Thus, in preferred embodiments, the MGS 306 includes one or more machine position sensors 324 that are used to sense the current position, orientation or heading, and speed of the machine 300 (or its various components) (collectively, “position data”). By providing this position data to the MGS 306, a desired travel path 302 can be derived. In FIG. 2 for example, the desired travel path 302 may be based on a known relative spacing between a position sensor 324 located on a particular machine 300 and another component of that machine (e.g., screed side plate). This other component may also be provided with a position sensor, the component requiring a specific location relative to the road-building site 100 (e.g., at the seam) to function optimally. The known relative spacing of the sensors and the components is then combined with a desired offset between the line 322 and the sensors to maintain the desired location of the machine component.

To identify the precise position of the critical points 320 within the model 312, each of the scans 314 that form the model 312 are preferably analyzed by one or more computer-based processing units 326 (shown in FIG. 13) associated with the MGS 306. As with most sets of data, certain data analysis techniques or data conditioning may be required or desirable to obtain a higher quality data set. Thus, when identifying the position of critical points 320 in the model 312, the processing units 326 may apply certain filters to remove noise or outliers 320′ in the data set. In this case, the outliers 320′ are locations within the model 312 that were previously mis-identified as having a location that corresponds with the location of the reference point (i.e., the seam 108). Other data filtering may be necessary or desired in order tailor the data to obtain a more ideal data set. For example, it might be necessary to remove or limit the number of critical points 320 identified to speed up processing of the data and the generation of line 322.

The line 322, itself, is preferably plotted based on a curve that best fits or that connects the plurality of critical points. Any predictive analytical methods may be used to fit the line 322 to the data. For example, in certain embodiments, linear regression is used to fit a curve to the critical points. This line 322 may, of course, be updated as the MGS 306 is provided with updated information. For example, in preferred embodiments, as the machine 300 continues to gather data via the sensors 310 as it travels along the road-building site 100 and to provide that data to the MGS 306. As that data is gathered and provided to the MGS 306, the line 322 and desired travel path 302 are updated. Preferably, this happens in real time and continuously or semi-continuously. For example, in certain preferred embodiments, the desired travel path 302 is updated at least 10 times per second.

Preferably, the above-described data collection and data manipulation and the generation of the line is carried out partially or entirely automatically and programmatically by the MGS 306. For example, for certain commonly occurring structures or features at road-building sites 100 often used in the creation of a desired path or line 322 for road construction machines 200, computer-based “profiles” are created that automate the creation process of that desired path or one or more portions of that creation process. This automation process might include certain steps used in collecting data (e.g., identifying appropriate points of reference), improving the data (e.g., filtering outliers 320′) and manipulating data (e.g., fitting a line 322 to the data). The profiles may employ a variety of algorithms to optimize performance in the manner discussed above. In certain preferred embodiments, artificial intelligence, such as trained machine learning algorithms and neural networks, is used in one or more of these automated processes.

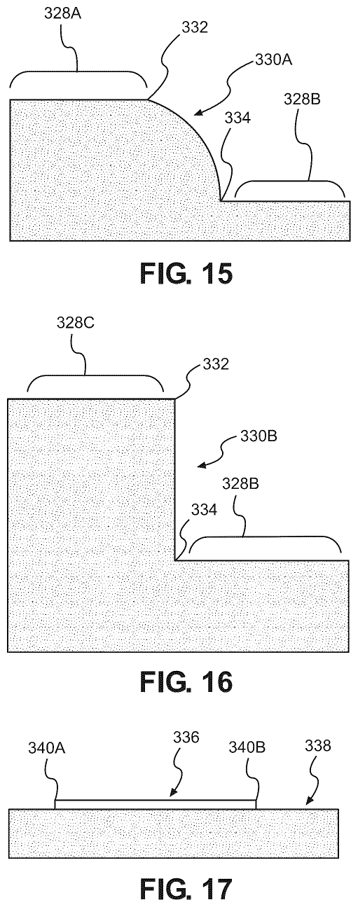

With continued reference to FIG. 14 and with further reference to FIGS. 15-17, three examples of commonly occurring structures or features that are often found at road-building sites 100 are illustrated. In FIG. 15, a site condition is presented that is like that shown in FIG. 1, where a partially-completed road surface is shown including a paved portion 328A abutting an unpaved portion 328B along a longitudinal joint or seam 330A. The seam 330A is somewhat gradual or curved and has a top portion 332 that is located at the same elevation as the top of the paved portion 328A and a bottom portion 334 that is located at the same elevation as the top of the unpaved portion 328B. A smooth, non-vertical transition is provided between the top portion 332 and the bottom portion 334 of the seam 330A. The transition between the paved portion 328A and the top portion 332 of the seam 330A is smooth or gradual, whereas the transition between the bottom portion 334 of the seam and the unpaved portion 328B is abrupt. In FIG. 16, a straight cut edge situation is shown, where a partially-completed road surface is shown that includes a paved or raised portion 328C abutting the unpaved portion 328B along a longitudinal joint or seam 330B. The seam 330B includes a top portion 332 and a bottom portion 334. However, a primary difference between this straight cut edge scenario and the prior scenario shown in FIG. 15 is that, for straight cut edges, the transitions between both the paved portion 328A and the top portion 332 of the seam 330B and the bottom portion 334 of the seam and the unpaved portion 328B are abrupt (i.e., sharp and not gradual). In each of these cases, there is an appreciable difference in elevation between the top and bottom portions 332, 334 of the seams 330A, 330B. On the other hand, the structure shown in FIG. 17 is fairly different from those shown in FIGS. 15 and 16. In FIG. 17, a painted line 336 is shown on top of a paved surface 338 and where the vertical thickness of the painted line 336 is exaggerated. The difference in height when comparing the seams 330A, 330B shown above and this paint line 336 might be one way to distinguish the structures. Identifiable features that are unique to the scenario shown in FIG. 17 might include the width of the painted line 336 between its left end 340A and right end 340B, which should remain consistent and be easily identified. Another potentially identifiable feature is the difference in color between the lighted-colored painted line 336 and the darker-colored paved surface 338.

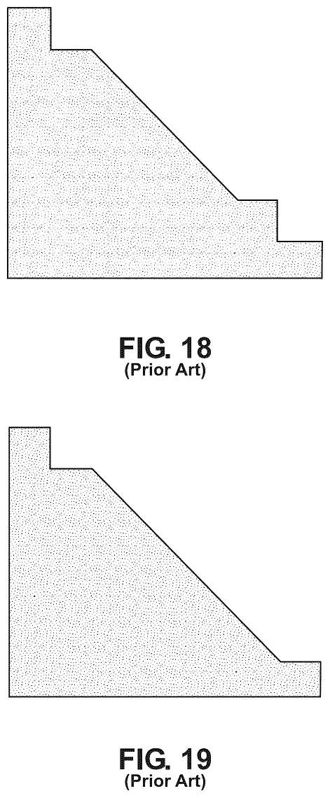

Preferably, in each of the above-described situations, the MGS 306 may be configured or programmed to identify or account for these common features when scanning that particular type of structure. This might be done, for example, following an initial scan of the road-building site 100 by the sensors 310 of the machine 300. Advantageously, this would allow for the processing of the data collected on by the MGS to be faster, more consistent, and more accurate. In other words, because the MGS 306 knows what features should be present for a given structure, those features can be identified more readily. In certain embodiments of the invention, the MGS 306 can identify these structures or features itself upon scanning them, such as through a trained machine learning algorithm. In other cases, an operator or user may select one of multiple selectable preprogrammed edge profiles that identify the relevant structure or feature to modify the behavior of the MGS 306. The above three scenarios are merely examples of structures or features that commonly occur at road-building sites that could be programmed into the MGS 306. It may be appreciated that many other and different structures and features could also be identified, and the MGS 306 may be programmed to account for those other structures as well. For example, in FIG. 18 and FIG. 19, examples of conventional longitudinal boundary conditions, sometimes called safety or shovel edges, are illustrated. These kinds of angled edges are commonly found along edges of roadways to avoid sharp drops, which can assist in preventing car crashes and assist drivers to re-enter the paved road more safely. Preferred embodiments of the present invention are capable of detecting and accounting for these kinds of safety edges.

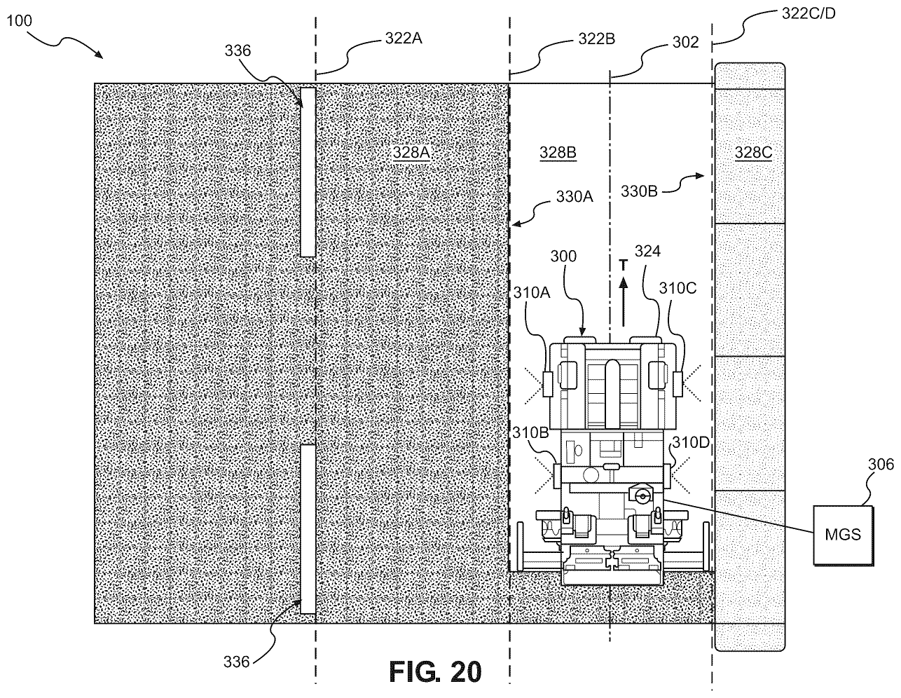

Finally, FIG. 20 provides an overhead view depicting a road construction machine 300 having an MGS 306 or being in communication with such an MGS according to an embodiment of the present invention. Machine 300 is located at a road-building site 100 that features all three of the preprogrammed structures shown in FIGS. 15-17 and discussed above. More particularly, this building site 100 includes a paved 2-lane raised portion 328A having intermittent painted white lines 336 (as seen in FIG. 17), an unpaved portion 328B, a raised sidewalk portion 328C, a gradual seam 330A (as seen in FIG. 15) located on the left side of the machine, and a straight seam 330B (as seen in FIG. 16) located on the right side of the machine. Two laser-based sensors 310A, 310B are located on the left side of the machine 300 and two more sensors 310C, 310D are located on the right side of the machine.

Each of the sensors 310A-310D is configured to scan a portion of the road-building site 100 in order to collect data and, preferably, to produce a corresponding line (See Ref. Nos. 322A-322D) that may be used in the creation and verification or improved accuracy of a desired travel path 302. In particular, sensor 310A may be used to scan the intermittent painted white lines 336. Those scans may then be combined with other information, such as the location of and spacing between components of the MGS 306 (e.g., sensor 310A and a machine position sensor), to create line 322A within a 3-D model of the road-building site 100 according to the methods discussed above. At the same time, sensor 310B may also be used to scan the gradual seam 330A, which may then be used by MGS 306 to create line 322B. Lastly, sensors 310C and 310D may each be used to scan the straight seam 330B independently of one another, which may then be used by MGS 306 to create lines 322C and 322D, respectively. Then, based on these lines 322A-322D, a desired travel path 302 may be generated. Each of the independently-created lines 322A-322D may be used to independently determine a separate travel path 302. Those separate travel paths 302 may then be compared to one another for error checking purposes, averaged together, etc. Preferably, this process is repeated continuously or semi-continuously such that the travel path 302 is updated in real time.

Finally, the MGS 306 may be configured to provide instructions to an operator that instructs them on how to modify the current position, heading and speed of the machine 300 to conform to the desired travel path 302. An operator then uses these instructions to adjust the current position of the road construction machine 300. Alternatively, the road construction machine 300 can include a controller for receiving the instructions from the MGS 306 and automatically adjusting the needed characteristic of the road construction machine 300 to align the current position with the desired travel path 302, i.e., steering or speed, upon receipt.

As noted previously, the desired travel path 302 is like a flight plan used in the air travel industry. In certain embodiments, the MGS 306 provides instructions for aligning the current position with the desired travel path 302. These instructions (e.g., “steer left” or “slow down”) could be provided to the operator via a display on the machine 300. Based on those instructions, the operator could adjust the current position, heading, and speed of the road construction machine 300 to conform with the desired travel path 302. However, in preferred embodiments, the MGS 306 includes an “auto pilot” feature capable of controlling the operation (e.g., position, heading, speed, and other machine functions such as whether a paint sprayer on the machine is turned off or on) of the machine 300 such that the machine stays on the desired travel path 302.

Although this description contains many specifics, these should not be construed as limiting the scope of the invention but as merely providing illustrations of some of the presently preferred embodiments thereof, as well as the best mode contemplated by the inventor of carrying out the invention. The invention, as described herein, is susceptible to various modifications and adaptations as would be appreciated by those having ordinary skill in the art to which the invention relates.

What is claimed is:

1. A road construction system for positioning a working apparatus of a road construction machine with respect to the road construction machine and with respect to a road surface as the road construction machine travels along a portion of the road surface, the system comprising:
the road construction machine;
the working apparatus, wherein the working apparatus is located on and carried by the road construction machine such that a first area is located forward of the working apparatus and a second area is located rearward of the working apparatus;
a positioning system including a controller for executing instructions in order to change a position or orientation of the working apparatus with respect to the road construction machine and the road surface and a computer system having a processor for processing data;
one or more sensors configured to collect topographical data for three or more different points of interest in the first area and to provide the topographical data to the positioning system;
wherein the computer system is configured to:
process the topographical data to generate a first plane equation for a first plane containing at least three of the three or more different points of interest in the first area,
to compare the first plane equation with an initial position of the working apparatus to determine a second position of the working apparatus calculated to enable the working apparatus to change the road surface from a first state to a second state in order to carry out a road construction operation, and
to generate instructions for changing a position or orientation of the working apparatus from the initial position to the second position,
wherein the controller is configured to receive the instructions from the computer system and to execute the instructions to cause the positioning system to move the working apparatus from the initial position to the second position.

2. The system of claim 1 wherein the plane equation provides a plane that represents a best fit of the three or more different points of interest in the first area.

3. The system of claim 1 wherein: the road construction machine comprises a cold planer, the working apparatus comprises a milling drum, the first state of the road surface is an un-milled state, and the second state of the road surface is a milled state.

4. The system of claim 1 wherein the sensors comprise vision sensors.

5. The system of claim 1 wherein:
the processor is further configured to generate a tolerance band related to the plane equation, and
if the computer system receives topographical data outside of the tolerance band, the computer system generates an alarm.

6. The system of claim 1 wherein:
the computer system is further configured to analyze the topographical data using a machine learning (ML) engine and determine if the topographical data corresponds with the road surface or not,
if the ML engine determines the topographical data corresponds with the road surface, the computer system integrates the topographical data into the plane equation, and
if the ML engine determines the topographical data does no corresponds with the road surface, the computer system generates an alarm.

7. The system of claim 1 further comprising at least one sensor configured to sense one or more sensed areas comprising a newly worked area rearward of the working apparatus, to generate topographical data related to the newly worked area, and to provide the topographical data related to the newly worked area to the positioning system,
wherein, in response to the positioning system receiving the topographical data related to the newly worked area, the processor processes the data to determine if the road surface at the newly worked area is in the second state, and
wherein, if the road surface at the newly worked area is not in the second state, the computer system generates instructions for changing the position of the working apparatus from the second position to a third position.

8. The system of claim 1, wherein:
the road construction machine includes a chassis and ground contact points (GCP) that is disposed on the chassis and that is configured to contact the road surface and to propel the road construction machine along the portion of the road surface, the GCP being height-adjustable with respect to the chassis;
at least one sensor of the one or more sensors is configured to take a distance measurement of a distance between the GCP and is further configured to provide the distance measurement to the computer system; and
the computer system is configured to utilize the distance measurement in generating the plane equation and to generate instructions for adjusting a height of the GCP with respect to the chassis.

9. A method for positioning a working apparatus of a road construction machine with respect to the road construction machine and with respect to a road surface as the road construction machine travels along a portion of the road surface, the method comprising the steps of:
providing:
the road construction machine;
the working apparatus, wherein the working apparatus is located on and is carried by the road construction machine such that a first area is located forward of the working apparatus and a second area is located rearward of the working apparatus;
a positioning system including a controller for executing instructions in order to change a position or orientation of the working apparatus with respect to the road construction machine and the road surface and a computer system having a processor for processing data;
one or more sensors configured to collect topographical data for three or more different points of interest in the first area and to provide the topographical data to the positioning system;
wherein the computer system is configured to:
process the topographical data to generate a first plane equation for a first plane containing at least three of the three or more different points of interest in the first area,
to compare the first plane equation with an initial position of the working apparatus to determine a second position of the working apparatus calculated to enable the working apparatus to change the road surface from a first state to a second state in order to carry out a road construction operation, and
to generate instructions for changing a position or orientation of the working apparatus from the initial position to the second position,
wherein the controller is configured to receive the instructions from the computer system and to execute the instructions to cause the positioning system to move the working apparatus from the initial position to the second position;
providing the initial position of the working apparatus to the computer system;
providing a desired operational constraint of the working apparatus to the computer system;
with the one or more sensors, collecting topographical data for three or more different points of interest in the first area and providing the topographical data to the positioning system;
with the computer system:
processing the topographical data to generate the first plane equation;
comparing the first plane equation, the desired operational constraint, and the initial position of the working apparatus; and
generating instructions to move the working apparatus to a second position calculated to enable the working apparatus to change the road surface from a first state to a second state, and
with the controller, executing the instructions.

10. The method of claim 9 wherein the first plane equation provides a plane that represents a best fit of the three or more different points of interest in the first area.

11. The method of claim 9 further comprising:
moving the road construction machine in a travel direction over the road surface in a first pass;
during the first pass, with the one or more sensors, collecting topographical data for three or more different points of interest of a second and different area, and providing the topographical data to the computer system;
with the computer system, updating the plane equation with the topographical data for the second and different area to provide an updated plane equation;
with the computer system:
processing the topographical data for the second and different area to generate an updated plane equation;
comparing the updated plane equation, the desired operational constraint, and the second position of the working apparatus; and
generating instructions to move the working apparatus to a third position; and
with the controller, executing the instructions.

12. The method of claim 11 further comprising:
after the road construction machine completes the first pass, storing the topographical data related to the first area and second area as a first data set in the computer system;
moving the road construction machine over the road surface in a second pass;
during the second pass, with the one or more sensors, collecting topographical data for three or more different points of interest of a third and different area, and providing the topographical data to the computer system;
storing the topographical data related to the third area as a second data set in the computer system;
based on the first data set and the second data set, calculating a revised plane equation; and
generating instructions to move the working apparatus to an updated position.

13. The method of claim 9 wherein the road construction machine comprises a cold planer, the working apparatus comprises a milling drum, the first state of the road surface is an un-milled state, and the second state of the road surface is a milled state.

14. The method of claim 9 wherein:
the processor is further configured to generate a tolerance band related to the plane equation, and
if the computer system receives topographical data outside of the tolerance band, the computer system generates an alarm.

15. The method of claim 14 wherein the processor generates the tolerance band utilizing the topographical data and statistical analysis, algorithms, or data processing filters.

16. The method of claim 9 further comprising providing at least one sensor configured to sense one or more sensed areas comprising a newly worked area rearward of the working apparatus, to generate topographical data related to the newly worked area, and to provide the topographical data related to the newly worked area to the positioning system,
wherein, in response to the positioning system receiving the topographical data related to the newly worked area, the processor processes the data to determine if the road surface at the newly worked area is in the second state, and
wherein, if the road surface at the newly worked area is not in the second state, the computer system generates instructions for changing the position of the working apparatus from the second position to a third position.
